(19) United States
(12) Patent Application Publication
(10) Pub. No.: US 2005/0242109 A1
(43) Pub. Date: Nov. 3, 2005

(54) LIQUID STORAGE AND DISPENSING SYSTEM AND METHOD

(75) Inventor: Richard J. Reed, Slidell, LA (US)

Correspondence Address: MCGARRY BAIR PC, 171 MONROE AVENUE, N.W., SUITE 600, GRAND RAPIDS, MI, 49503, US

(73) Assignee: AVON RUBBER & PLASTICS, INC., Cadillac, MI (US)

(21) Appl. No.: 10/907,960

(22) Filed: Apr. 22, 2005

Related U.S. Application Data
(60) Provisional application No. 60/521,467, filed on Apr. 30, 2004.

(51) Int. Cl. G01F 11/00

(52) U.S. Cl. 222/1

(57) ABSTRACT

A liquid storage and dispensing system comprises a bladder, a container in fluid communication with the bladder, a pump in fluid communication with the container, and a dispensing conduit in fluid communication with the pump. Liquid stored in the bladder flows from the bladder to the container, and the pump draws the liquid from the container and dispenses the liquid through the dispensing conduit. The container is sized such that it can store the other components of the liquid storage and dispensing system, including the bladder, which can be collapsed and folded into a compact configuration.

### CROSS REFERENCE TO RELATED APPLICATION

This application claims the benefit of U.S. provisional application Ser. No. 60/521,467, filed Apr. 30, 2004, which is incorporated herein by reference in its entirety.

### FIELD OF THE INVENTION

The invention relates to a liquid storage and dispensing system. In one aspect, the invention relates to a self-contained system for storing and dispensing a liquid in a remote location. In another aspect, the invention relates to liquid storage and dispensing kit that can be easily transported to a remote location and assembled to form a self-contained liquid storage and dispensing system. In yet another aspect, the invention relates to a self-contained system for storing and dispensing fuel in a remote location. In yet another aspect, the invention relates to a self-contained system for storing and dispensing water or other liquid in a remote location. In another of its aspects, the invention relates to a method of constructing a remote liquid storage and dispensing system.

### DESCRIPTION OF THE RELATED ART

When fuel-powered machinery and equipment operate in remote locations or locations that are distant from a fuel source, supplying fuel to the machinery and equipment can be problematical. Either the machinery and equipment must be transported to the source of fuel, or the fuel has to be delivered to the remote location. In the latter case, fuel can be supplied to a fuel storage and delivery system that is stationed at the remote location. Storage and dispensing systems that have a relatively large volumetric capacity suitable for refueling machinery and equipment typically comprise heavy and bulky structures that relatively costly and can only be transported from one location to another with special vehicles.

For example, U.S. Pat. No. 5,537,066 to Vaillancourt et al. discloses a remote fuel station comprising a box-shaped steel shell with walls and a door that form an enclosure to house a fuel tank or bladder. Rectangular sleeves or crossbars are positioned on the bottom of the shell and are adapted to receive the tines of a fork lift vehicle. Fuel from the tank is pumped through conduits leading from the tank to a delivery nozzle. U.S. Pat. No. 5,400,924 to Brodie discloses an above ground fuel storage system comprising a rectangular containment vessel that houses a fuel tank. The vessel is preferably made of reinforced concrete and is constructed with a lifting lip near the bottom edge of the walls. The vessel can be raised from the ground and transported by engaging jacks with the lip and raising the jacks. The pump for dispensing fuel from the tank can be solar-powered or fuel-powered. These and other prior art systems effectively function as mini-service stations and are appropriate in circumstances where a such a structure is desired; however, for some applications, a simpler, easily transportable, and self-contained fuel storage and dispensing system is desirable.

It has become important to set up camps for military and other professional personnel in remote areas that may or may not have a source of potable water. Typically, in may instances, these camps are temporary and require construction and deconstruction in relatively short periods of time. Potable water is a critical resource and large reservoirs need to be transported and stored for human use in these camps in short periods of time and without the use of massive construction or the use of heavy equipment.

### SUMMARY OF THE INVENTION

According to one embodiment of the invention, a liquid storage and dispensing system comprises a bladder having a first capacity for storing a liquid; a container in fluid communication with the bladder and having a second capacity smaller than the first capacity; a pump in fluid communication with the container; and a dispensing conduit in fluid communication with the pump; wherein the liquid stored in the bladder is adapted to flow from the bladder to the container, and the pump is adapted to draw the liquid from the container and dispense the liquid through the dispensing conduit.

In a preferred embodiment of the invention, the bladder is adapted to be filled with the liquid by supplying the container with the liquid, which flows from the container to the bladder. In one embodiment, the pump is a manual pump. In another embodiment, the pump is an electrical pump. In another embodiment, the pump is a hydraulic pump.

According to another embodiment, the liquid is fuel. When the liquid is fuel, the liquid storage and dispensing system according to another embodiment further comprises an electrical ground mounted to the container. In yet another embodiment, the liquid stored in the bladder and dispensed from the pump is water.

According to another embodiment, the bladder is made of a polymer. Exemplary polymers include, but are not limited to, a thermoplastic elastomer, a thermoplastic urethane, and a thermoset rubber. According to one embodiment, the bladder is made from one of a nitrile rubber and a polyurethane. According to another embodiment, the bladder is made of a composite fabric. Exemplary composite fabrics include, but are not limited to, polymer reinforced aramid. The material used in the bladder nd in the connecting hose is selected to comport with the intended liquid that is to be stored in the bladder and dispensed from the pump.

According to one embodiment, the bladder is connected to the container through a disconnectable coupling. According to another embodiment, the bladder is connected to a hose that is connected to the container by the disconnectable coupling. According to yet another embodiment, the disconnectable coupling is a quick connect coupling.

According to another embodiment of the invention, the bladder is collapsible. The bladder and the container are sized so that the bladder, when collapsed, can be stored in the container. According to yet another embodiment, the hose, the disconnectable coupling, the pump, and the dispensing conduit are also sized to fit in the container, preferably with the bladder so that the entire liquid storage and dispensing system can be shipped in the container which is also used as a surge tank for dispensing the liquid and for filling the bladder.

According to another embodiment, the liquid stored in the bladder is adapted to flow from the bladder to the container under the force of gravity.

Further according to the invention, a liquid storage and dispensing kit comprises a collapsible bladder for storing a liquid and having an expanded state when the collapsible bladder is filled with the liquid and a collapsed state when the collapsible bladder is substantially empty, the collapsible bladder having an outlet opening; a pump adapted to be connected to the outlet opening of the collapsible bladder for drawing liquid from the collapsible bladder when the collapsible bladder contains the liquid; a dispensing conduit adapted to be coupled to the pump for dispensing the liquid drawn from collapsible bladder; and a container sized to store the pump, the dispensing conduit, and the collapsible bladder when the collapsible bladder is in the collapsed state.

According to another embodiment, the container is adapted to be connected between the pump and the collapsible bladder to facilitate filling the bladder with liquid and dispensing the liquid from the collapsible bladder.

According to yet another embodiment of the invention, the liquid storage and dispensing kit further comprises a disconnectable coupling adapted to connect the collapsible bladder to the container. Preferably, the liquid storage and dispensing kit further comprises a hose adapted to be connected to the disconnectable coupling to connect the collapsible bladder to the container. According to yet another embodiment of the invention, the disconnectable coupling is a quick connect coupling. According to another embodiment, the hose and the disconnectable coupling are sized to fit in the container with the pump, the dispensing conduit, and the collapsible bladder when the collapsible bladder is in the collapsed state.

Still further according to the invention, a method of constructing a remote liquid storage facility comprises the steps of providing a liquid storage and dispensing kit as described above in a first location; packing the collapsible bladder, the pump, and the dispensing conduit into the container at the first location; transporting the packed container to a second location remote from the first location; unpacking the container at the second location; coupling the collapsible bladder to the container, coupling the pump to the container; and coupling the dispensing conduit to the pump.

According to another embodiment, the method further comprises unfolding the collapsible bladder and laying it flat on a support surface.

According to another embodiment, the packing step includes folding the collapsible bladder into a size to fit within the container.

According to one embodiment, the method further comprises filling the collapsible bladder with a liquid through the container. According to another embodiment, the method further comprises dispensing the liquid from the collapsible bladder through the container. According to yet another embodiment, the dispensing step includes pumping the liquid from the container through the dispensing conduit.

### BRIEF DESCRIPTION OF THE DRAWINGS

FIG. 1 is a perspective view of a liquid storage and dispensing system according to the invention and comprising a container, in the form of a conventional drum, that stores other components of the liquid storage and dispensing system.

FIG. 2 is a perspective view of the other components that can be stored in the container of the liquid storage and dispensing system from FIG. 1.

FIG. 3 is a perspective view of a collapsible bladder from the liquid storage and dispensing system from FIG. 1.

FIG. 4 is a perspective view of the liquid storage and dispensing system from FIG. 1 in an assembled condition ready to dispense liquid stored in the collapsible bladder.

FIG. 5 is a perspective view of a pump assembly from liquid storage and dispensing system shown in FIG. 4.

FIGS. 6-11 illustrate steps in assembling the liquid storage and dispensing system from FIG. 1.

FIG. 6 is a perspective view illustrating placement of the container from FIG. 1 and the collapsible bladder from FIG. 3 on a level plane.

FIG. 7 is perspective view of a male camlock attached to a lower bunghole located on the container from FIG. 1 and a female camlock attached to a first half of a valve.

FIG. 8 is a perspective view showing the male and female camlocks from FIG. 7 mated to couple the first half of the valve to the container and also showing a second half of the valve attached to a transport hose.

FIG. 9 is a perspective view of the container from FIG. 1, wherein the first and second halves of the valve are mated, a telescoping suction pipe is inserted through a first bunghole in a lid of the container, and a vent assembly is mounted to a second bunghole in the lid.

FIG. 10 is a perspective view of the barrel from FIG. 9 further equipped with the pump assembly from FIG. 5 and a dispensing hose mounted to the pump assembly.

FIG. 11 is a perspective view of the container from FIG. 10 further equipped with an earthing assembly having an earthing rod that is partially inserted into the ground.

FIG. 12 is a perspective view of the container from FIG. 4 with the lid removed and the earthing assembly attached to the container so that liquid can be supplied to the container and delivered through the transport hose to the collapsible bladder.

### DESCRIPTION OF THE PREFERRED EMBODIMENT

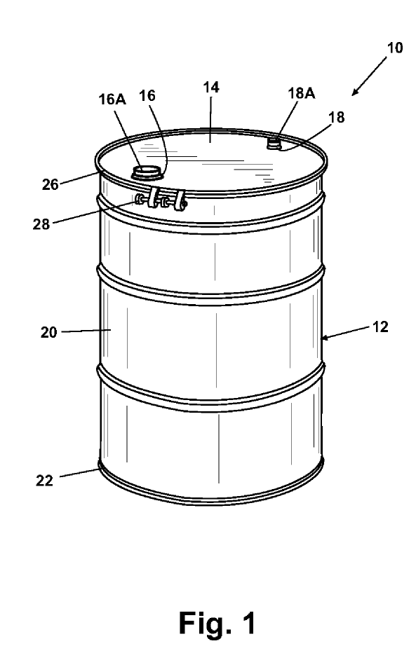

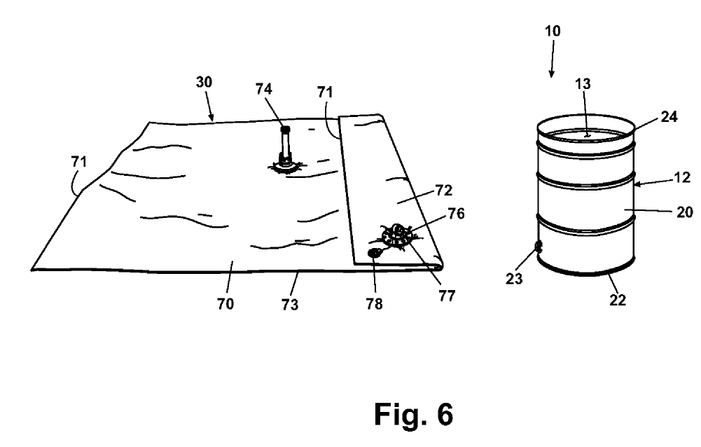

Referring now to the drawings, and in particular to FIG. 1, a self-contained liquid storage and dispensing system 10 according to the invention comprises a container 12 sized to receive all other components of the liquid storage and dispensing system 10. The container 12 functions as a storage unit for easy transportation of the liquid storage and dispensing system 10 and also participates in the storing and dispensing of liquid, as will be discussed in detail hereinafter. The container 12, which is shown in this embodiment as a standard 55 gallon drum, comprises a bottom wall (not shown) and an upwardly extending peripheral wall 20 with a lower rim 22 and an upper rim 24. A lower bunghole 23 (FIG. 6) with a corresponding bung (not shown) is disposed on the peripheral wall 20 near the lower rim 22. The bottom wall and the peripheral wall 20 form an open-top chamber 13 (FIG. 6) that can be closed with a removable lid 14. The lid 14 sits upon the upper rim 24 of the container 12 and is secured thereto with a locking ring 26 held together by a tightening bolt 28. To remove the lid 14 from the container 12, the tightening bolt 28 is loosened to thereby loosen the locking ring 26 so that the lid 14 can be lifted from the upper rim 24. The lid 14 comprises a first bunghole 16 and second bunghole 18 with corresponding first and second removable bungs 16A and 18A to selectively close the bungholes 16 and 18. Preferably, the first bunghole 16 is larger than the second bunghole 18. For example, the first bunghole 16 can have a diameter of about 2 inches, and the second bunghole 18 can have a diameter of about 0.75 inches. The bungholes 16, 18, and 23 all comprise threaded fittings (not shown) for securing components thereto.

Although the container 12 is illustrated in the drawings as the standard 55 gallon drum, the container 12 can have other shapes and sizes and is not limited to the container 12 shown in conjunction with the description of this embodiment. However, it is intended that the container 12 has a volume that is large enough to store the other components of the liquid storage and dispensing system 10. Additionally, the container 12 can preferably be handled by one or two persons, with or without the assistance of a dolly or similar device. Further, the container 12 is preferably sized such that it can fit into a standard pickup truck, sport utility vehicle, and the like. However, it will be apparent to one of ordinary skill that the liquid storage and dispensing system 10 can be scaled up and, thus, require a larger vehicle for transport. Additionally, the container 12 can be made of any suitable material, such as metal (e.g. galvanized steel, aluminum) or plastic, and can be lined or unlined.

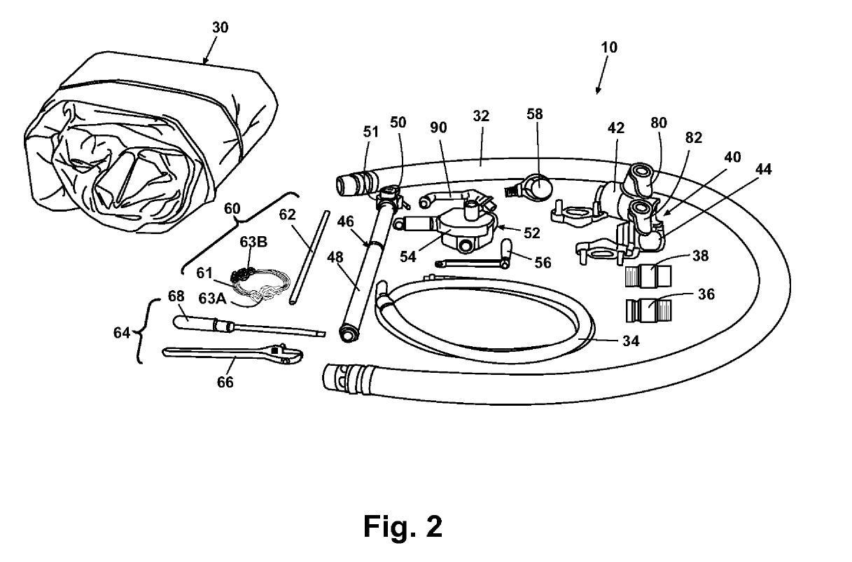

The other components of the liquid storage and dispensing system 10 are illustrated in FIG. 2. While the components are shown in FIG. 2 as unpacked from the container 12, the components can be packed into the container 12 for storage and transport, as explained above. Among the components is a collapsible bladder 20 for storing liquid and a transport conduit or hose 32 for transporting liquid between the bladder 20 and the container 12. The components further include a dispensing conduit or hose 34; a male camlock 36; a female camlock 38; a valve 40 comprising a first half 42 with a first handle 80 and a second half 44 with a second handle 82; a suction pipe 46 comprising a telescoping pipe 48 and a pump mount 50; a manual pump assembly 52 comprising a rotary pump 54 and a handle 56 for the rotary pump 54; a vent assembly 58; an earthing or grounding assembly 60 comprising an earthing rod 62 and clips 63A and 63B on the ends of a cord 61; and optional tools 64, such as a wrench 66 and a screwdriver 68, for assembling the liquid storage and dispensing system 10.

The liquid storage and dispensing system 10 is preferably and conveniently supplied with the components shown in FIG. 2 packed into the container 12. The lid 14 is secured to the container 12 with the locking ring 26, and the first and second bungs 16A and 18A plug the first and second bungholes 16 and 18, respectively. Further, the lower bunghole 23 is also closed by its bung (not shown). Because the liquid storage and dispensing system 10 is portable and supplied in a single container 12, the liquid storage and dispensing system 10 can be easily transported to a desired location and transferred to another location, if desired, without assistance from special machinery or vehicles. Further, because the container 12 participates in the dispensing of the liquid, a separate storage container is not necessary.

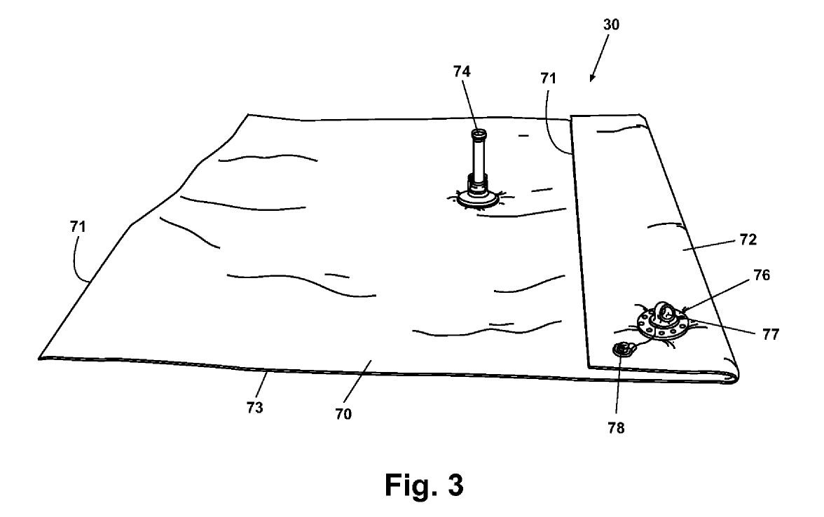

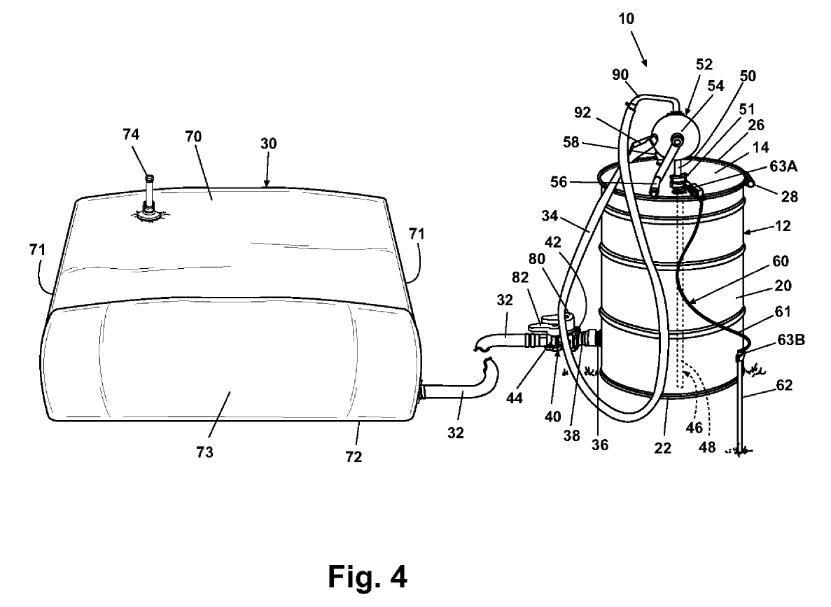

Referring now to FIGS. 3 and 4, the bladder 30 is a generally rectangular shaped body comprising an upper surface 70 and a lower surface 72 joined along a spaced side edges 71 and spaced side walls 73 oriented generally perpendicular to the spaced side edges 71. A vent assembly 74 is mounted to an opening in the upper surface 70. The vent assembly 74 can be preassembled to the bladder 30, or it can be supplied as a separate component that is attached to the bladder 30 by a user. Further, the bladder 30 comprises a fill/discharge drain assembly 76 on the lower surface 72. The drain assembly 76 includes an opening 77 and a removable plug 78 for selectively closing the opening 77. The bladder 30 is preferably composed of a pliable material, such as a thermoplastic elastomer (TPE), thermoplastic urethane (TPE), such as polyurethane, or thermoset rubber material, such as nitrile rubber, so that the bladder 30 can expand to an expanded state when filled with a liquid, as shown in FIG. 4, and collapse onto itself to a collapsed state, as illustrated in FIG. 3, as the liquid is dispensed from the bladder 30. Hence, the volume of the bladder 30 changes according to the amount of liquid contained therein, and the volume of the bladder 30 when in the expanded state is larger than the volume of the bladder 30 when in the collapsed state. Additionally, the bladder 30 in the collapsed state can be folded, rolled, or otherwise transformed into a compact configuration, as shown in FIG. 2, for storage in the container 12. Further, the material for the bladder 30 should be strong enough to support weight of the liquid stored therein and impervious to liquids, including hydrocarbon fuels. The material should preferably be relatively impervious to vaporous hydrocarbons as well. Alternative materials for the bladder 30 include fabrics and composites, such as industrial coated fabrics, including extruded or calandered polymer over aramid cloth that is woven, non-woven yarn, or monofilament. The bladder 30 has a maximum capacity that is significantly greater than the volume or capacity of the chamber 13 in the container 12. Typically, the maximum capacity of the bladder 30 can be about 1000 gallons, but it is within the scope of the invention for the maximum capacity of the bladder 30 to have a value other than 1000 gallons.

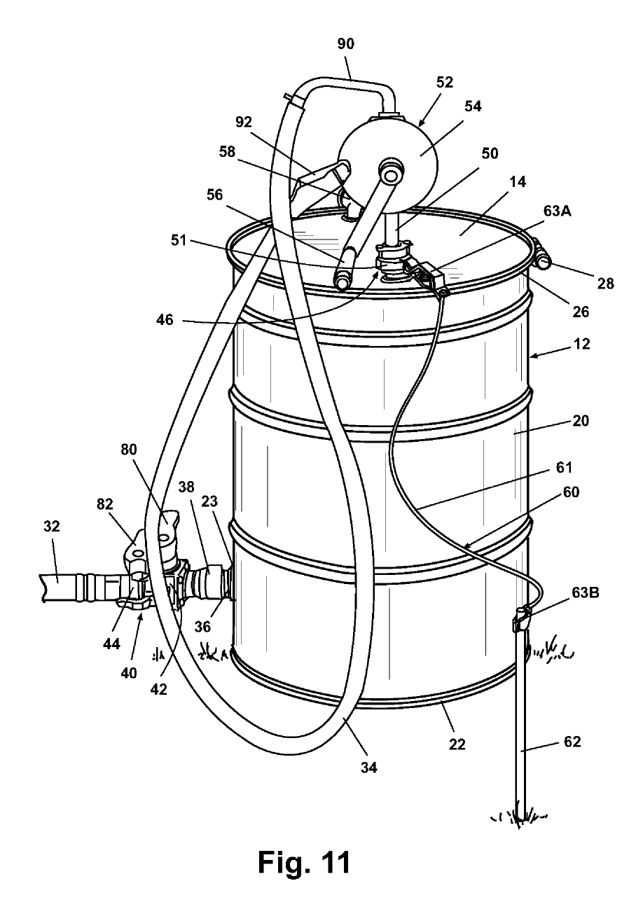

As shown in FIG. 4, when the liquid storage and dispensing system 10 is in an assembled condition, the bladder 30 is fluidly connected to the container 12 by the transport hose 32. The transport hose 32 is connected at one end to the drain assembly 76 on the bladder 30 at its other end to the second half 44 of the valve 40. The second half 44 of the valve 40, in turn, is connected to the first half 42 of the valve 40. The first half 42 of the valve 40 is coupled to the container 12 by the female camlock 36, which is connected to the first half 42 of the valve 40, and the male camlock 38, which is mounted to the lower bunghole 23 in the peripheral wall 20 of the container 12. The male and female camlocks 36 and 38 function as a fitting to couple the valve 40 to the container 12. The first and second valve handles 80 and 82 are movable between an open position, as shown in FIG. 4, wherein fluid can flow through the valve 40 between the bladder 30 and the container 12, and a closed position, as shown in FIG. 11, wherein fluid flow through the valve 40 and, thus, between the bladder 30 and the container 12 is prevented.

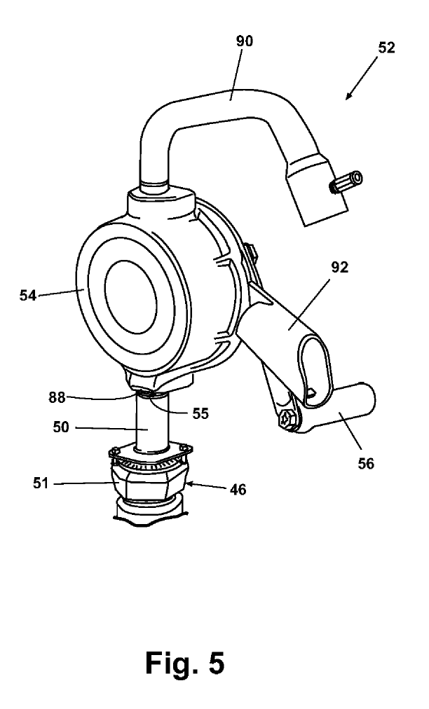

As best viewed in FIG. 5, the pump assembly 52 comprises, in addition to the rotary pump 54 and the handle 56, a hollow discharge elbow 90 that extends from the top of the rotary pump 54, a tube holder 92 that projects from the side of the rotary pump 54, and a threaded intake port 88 on the bottom of the rotary pump 54. The discharge elbow 90 and the handle 56 can be preassembled onto the rotary pump 54 or can be supplied as separate components. The intake port 88 is in fluid communication with the discharge elbow 90, and manual rotation of the handle 56 draws fluid in from the intake port 88 and expels fluid through the discharge elbow 90. The intake port 88 is sized to receive the pump mount 50 of the suction pipe 46.

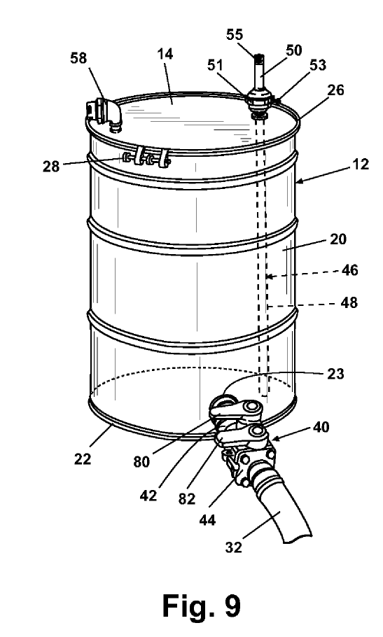

As stated above, the suction pipe 46 comprises the telescoping pipe 48 and the pipe mount 50. The telescoping pipe 48 is supplied in a retracted state, as shown in FIG. 2, so that it can fit within the container 12 for storage and transport and can be extended to an elongated state, as shown in FIG. 4, wherein the length of the telescoping pipe 48 can be as long as the height of the container 12. As best viewed in FIG. 9, the pump mount 50 includes a packing gland 51, a setscrew 53, and a threaded end 55 designed to mate with the intake port 88 of the rotary pump 54.

Referring again to the assembled liquid storage and dispensing system 10 shown in FIG. 4, the suction pipe 46 is mounted to the container 12 such that the telescoping pipe 48 is disposed within the chamber 13 and extends from the first bunghole 16 in the lid 14 to or near the bottom wall of the container 12, and the pump mount 50 projects above the first bunghole 16. The pump mount 50 of the suction pipe 46 mates with the intake port 88 of the pump assembly 52 such that the suction pipe 46 supports the pump assembly 52 and fluidly communicates the pump assembly 52 with the chamber 13. The setscrew 53, in a tightened condition, prevents the pump assembly 52 from undesirably rotating relative to the pump mount 50. The dispensing hose 34 is attached at one end to the discharge elbow 90, and its other end functions as a nozzle for dispensing liquid. When not in use, the nozzle end of the dispensing hose 34 can reside within the tube holder 92 on the pump assembly 52, as shown in FIG. 4. The vent assembly 58, which is mounted in the second bunghole 18, vents the chamber 13 of the container 12.

The earthing assembly 60, including the earthing rod 62, the cord 61, and the clips 63A and 63B, which are all composed of a conductive material, such as metal, electrically communicate the liquid storage and dispensing system 10 with an electrical ground. Preferably, the clip 63A on one end of the cord 61 fastens to the setscrew 53, and the clip 63B on the other end of the cord 61 grips the earthing rod 62, which is preferably inserted at least partially into the ground. If it is not feasible to insert the earthing rod 62 into the ground, the earthing rod 62 can be connected to another source of electrical ground.

An exemplary description of the assembly of the liquid storage and dispensing system 10 follows. It will be apparent to one of ordinary skill that the assembly procedure can proceed in any logical order and is not limited to the sequence presented below. The following description is for illustrative purposes only and is not intended to limit the invention in any manner.

To begin assembly, a user removes the first and second bungs 16A and 18A from the first and second bungholes 16 and 18, respectively, and the bung (not shown) from the lower bunghole 23. The user then loosens or removes the bolt 28 to loosen the locking ring 26 and removes the lid 14 from the container 12. Next, the user empties the contents of the container 12, as shown in FIG. 2. The optional tools 64, if provided in the container 12, can be used during appropriate steps of the assembly process.

The bladder 30 is then unfolded and spread out onto a flat surface, such as the ground, with the upper surface of the bladder 70 facing away from the flat surface, as shown in FIG. 3. If a flat surface is not available, then the bladder 30 can be spread out onto another suitable surface. The lower surface 72 of the bladder 30 should face the flat surface, but a portion of the bladder 30 can be temporarily folded over, as illustrated in FIG. 3, to provide access to the drain assembly 76 for connection of the transport hose 32, as will be described hereinafter. The user then removes the plug 78 from the drain assembly 76. If the vent assembly 74 is supplied separate from the bladder 30, the user attaches the vent assembly 74 to the bladder 30 so that it projects away from the upper surface 70.

Next, the user positions the empty container 12 on level ground and on a plane level with the bladder 30, as shown in FIG. 6. The positioning of the container 12 on the level plane relative to the bladder 30 ensures that the bladder 30 can be filled to its maximum capacity and that liquid can flow between the container 12 and the bladder 30 under the force of gravity. The distance between the container 12 and the bladder 30 can be any distance equal to or less than the length of the transport hose 32.

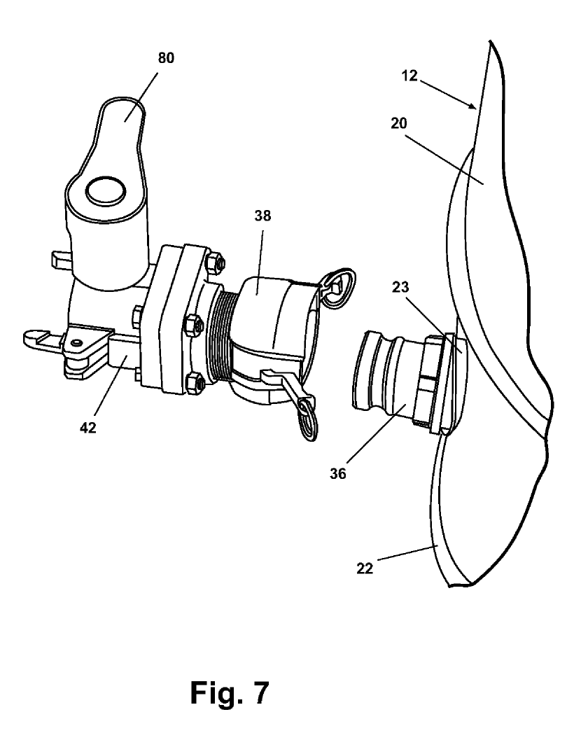

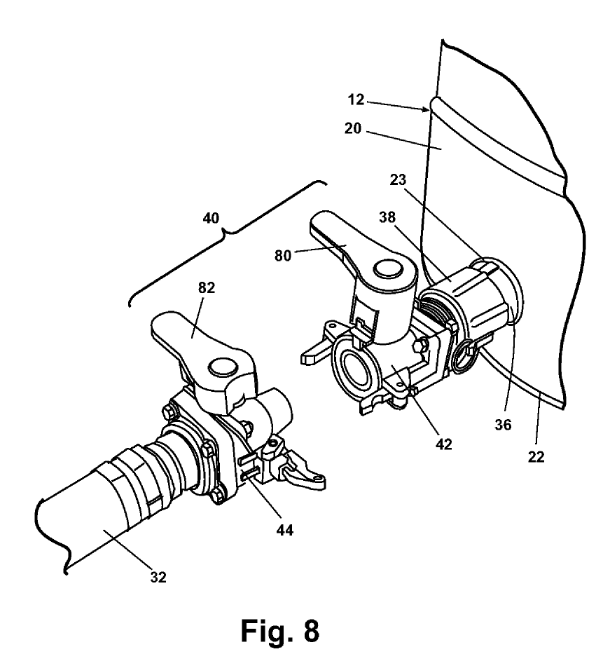

Referring now to FIG. 7, the male camlock 36 is attached to the lower bunghole 23, and the female camlock 38 is likewise attached to the first half 42 of the valve 40. The first handle 80 should be in the closed position, which, as depicted in the figures for this embodiment, is generally perpendicular to a flow path through the valve 40. Then, as shown in FIG. 8, the male and female camlocks 36 and 38 are connected together to couple the first half 42 of the valve 40 with the container 12. With continued reference to FIG. 8, the second half 44 of the valve 40, with the second handle 82 in the closed position, is attached to one end of the transport hose 32. Next, the first and second halves 42 and 44 of the valve 40 are joined together, as shown in FIG. 9. The camlocks 36 and 38 and the valve 40 are commonly known devices and are joined together in a conventional fashion. The camlocks 38 and the valve 40 form a disconnectable coupling between the transport hose 42 and the container 12, and, preferably, the camlocks 38 and the valve 40 form a quick connect coupling, whereby the camlocks 38 and the valve 40 can be connected and disconnected quickly with the assistance of few or no separate tools. After the one end of the transport hose 32 is coupled to the valve 40 and, thus, the container 12, the user aligns the other end of the transport hose 32 with the opening 77 in the drain assembly 76 and attaches the other end of the transport hose 32 to the drain assembly 76.

The next steps in the assembly of the liquid storage and dispensing system 10 involve setting up the pump assembly 52. First, the user replaces the lid 14 onto the container 12 and secures the lid 14 with the locking ring 26 and the bolt 28. Next, the telescoping pipe 48 of the suction pipe 46 is extended to its full length and inserted through the first bunghole 16. The suction pipe 46 is positioned so that the telescoping pipe 48 terminates near the bottom wall of the container 14 and the pump mount 50 projects above the lid 14, as shown in FIG. 9. The suction pipe 46 and the bunghole fitting (not shown) are tightened to form a snug fit between the suction pipe 46 and the lid 14. The user then inserts the vent assembly 58 into the fitting on the second bunghole 18 and tightens the vent assembly 58 and the fitting to form a snug fit between the vent assembly 58 and the lid 14.

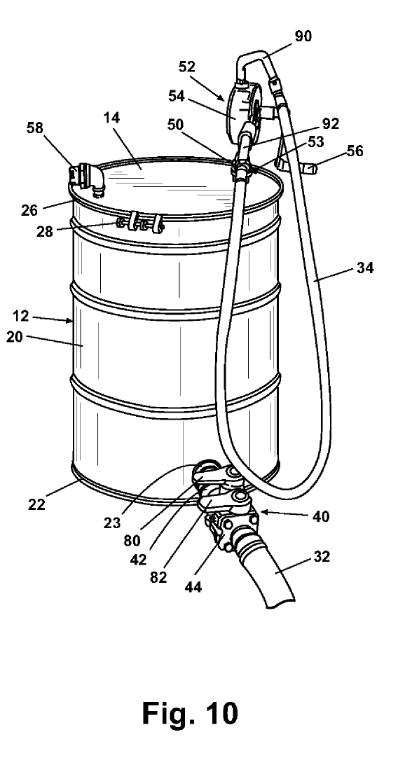

Referring now to FIG. 10, the pump assembly 52 is mounted to the pump mount 50 on the suction pipe 46 by screwing the intake port 88 onto the threaded end 55 of the pump mount 50. If the pump assembly 52 is not preassembled, the user then connects the discharge elbow 90 and the handle 56 to the rotary pump 54. Next, the user attaches one end of the dispensing hose 34 to the discharge elbow 90 and places the other end of the dispensing hose 34 in the tube holder 92. Thereafter, the user gently pushes down on the pump assembly 52 until the telescoping pipe 48 touches the bottom wall of the container 12. The user tightens the packing gland 51 to secure the suction pipe 46 in position and tightens the setscrew 53 to prevent the pump assembly 52 from turning relative to the pump mount 50.

Referring now to FIG. 11, the last step in the assembly of the liquid storage and dispensing system 10 is attaching the earthing assembly 60. First, the user drives the earthing rod 62 vertically into the ground or couples the earthing rod 62 with another source of electrical ground. The user then fastens the clips 63B and 63A to the earthing rod 62 and the setscrew 53, respectively.

To use the liquid storage and dispensing system 10 at a remote location, the liquid storage and dispensing system 10 in a disassembled condition is provided at a first location in a packed condition, wherein the components are stored in the container 12, or an unpacked condition, wherein the components are not stored in the container 12. In the latter case, the components are packed into the container 12, and the bladder 30 is collapsed and folded or otherwise manipulated into the compact configuration so that the bladder 30 fits within the container 12. Next, the packed container 12 is shipped or otherwise transported to a second location remote from the first location. At the second location, the packed container 12 is unpacked, and the liquid storage and dispensing system 10 is assembled as described above.

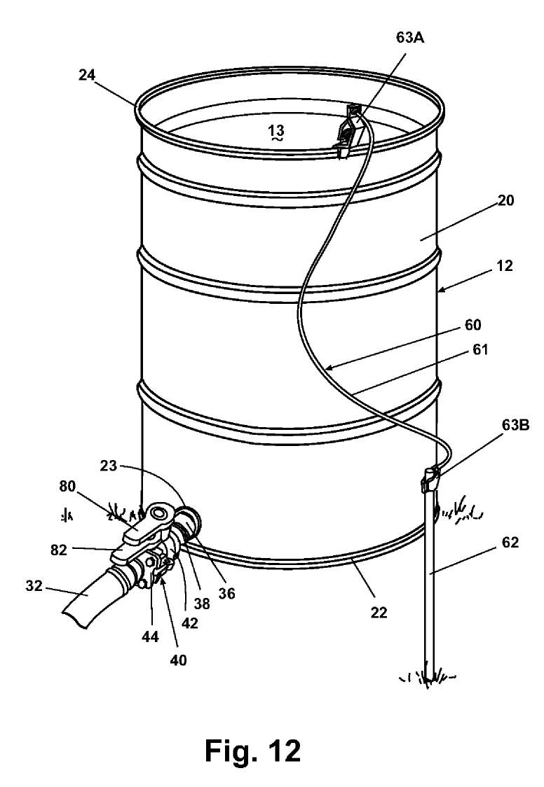

To operate the assembled liquid storage and dispensing system 10, the bladder 30 must be filled with liquid before the liquid storage and dispensing system 10 can be used to dispense the liquid. Referring now to FIG. 12, the valve handles 80 and 82 are rotated to the open position, which, as depicted in the figures for this embodiment, is generally parallel to the flow path through the valve 40. Next, the clip 63A of the earthing assembly 60 is removed from the setscrew 53, and the lid 14 is removed from the container 28 by loosening the bolt 28 and the locking ring 26, as described previously. When the lid 14 is removed, the vent assembly 58, the pump assembly 52, and the suction pipe 46 are removed along with the lid 14. The user then attaches the clip 63A to the upper rim 24 of the container 12. Subsequently, the bladder 30 is filled through the container 12. The liquid is dispensed from a liquid source into the chamber 13 of the container 12, and, because the bladder 30 and the container 12 are positioned on a level plane, the liquid flows under the force of gravity from the container 12, through the valve 40, through the transport hose 32, through the opening 77 in the drain assembly 76, and into the bladder 30.

The fill rate is dependent on the dimensions of the components of the liquid storage and dispensing system 10 and on the relative positioning of the container 12 and the bladder 30. If the lower bunghole 23, the transport hose 32, and the drain opening 77 all have a diameter of about 2 inches, the capacity of the bladder 30 is about 1000 gallons, and the container 12 and the bladder 30 are on a level plane on level ground, then the maximum fill rate is about 50 gallons per minute. At this fill rate, the bladder 30 can be filled in about 20 minutes, which is a relatively short period of time for such a large volume of fluid. The dimensions provided above are exemplary, and it will apparent to one skilled in the art that the dimensions can be changed to adjust for desired fill rates and fill times.

To dispense the liquid from the bladder 30, the clip 63A is removed from the upper rim 24 of the container 12, the lid 14, along with the vent assembly 58, the pump assembly 52, and the suction pipe 46, is replaced onto the container 12, and the clip 63A is reattached to the setscrew 53. The liquid storage and dispensing system 10 is now in the condition shown in FIG. 4 and is ready to dispense the liquid stored in the bladder 30. The liquid flows from the bladder 30, through the transport hose 32, and into the chamber 13 of the container 12 under the force of gravity. Consequently, as long as there is liquid present in the bladder 30, a constant supply of the liquid is provided to the container 12. The user removes the dispensing hose 34 from the tube holder 92 and positions the end of the dispensing hose 34 at a desired delivery location. Next, the user grasps the handle 56 and rotates the handle 56 to manually pump the liquid from the chamber 13 of the container 12, through the telescoping pipe 48 of the suction pipe 46, through the rotary pump 54, through the discharge elbow 90, and out the dispensing hose 34. As the liquid is drawn from the container 12, the liquid from the bladder 30 flows to the container 12 to replenish the drawn liquid until the liquid in the bladder 30 is depleted. Because the liquid flows between the bladder 30 and the container 12 under the force of gravity, the relative positioning of the bladder 30 and the container 12 are important. If the bladder 30 is positioned on a plane below the container 12, for example, gravity will not draw the liquid from the former to the latter.

Preferably, the liquid that is stored in and dispensed from the bladder 30 is fuel, such as gasoline or other liquid hydrocarbons. When the liquid is fuel, the container 12 is preferably unlined, and the bladder 30 is preferably made from nitrile rubber or, alternatively, polyurethane. However, it will be apparent to one of ordinary skill that the liquid storage and dispensing system 10 can be utilized to store and dispense other liquids, such as water, beverages, paint, and the like. When the liquid storage and dispensing system 10 is utilized with inert liquids, the earthing assembly 60 can be omitted. Further, when the liquid storage and dispensing system 10 is used with liquids, such as water, for consumption by humans, the container 12 is preferably lined, and the bladder 30 is preferably made from polyurethane. Other components of the liquid storage and dispensing system 10, such as the transport hose 32 and the dispensing hose 34, can be modified as needed in accordance with the type of liquid.

The liquid storage and dispensing system 10 has been described as comprising a manually operated pump assembly 52. Such a pump assembly is advantageous in that it can be operated in locations where a source of power is not available. However, the manually operated pump assembly 52 can be replaced with a pump assembly that is powered by solar energy, wind energy, hydraulic fluid, an electric generator, batteries, fuel, fuel cells, or other sources of energy.

While the invention has been specifically described in connection with certain specific embodiments thereof, it is to be understood that this is by way of illustration and not of limitation. Reasonable variation and combination are possible with the scope of the foregoing disclosure without departing from the spirit of the invention, which is defined in the appended claims.

1. A liquid storage and dispensing system comprising:
a bladder having a first capacity for storing a liquid;
a container in fluid communication with the bladder and having a second capacity smaller than the first capacity;
a pump in fluid communication with the container; and
a dispensing conduit in fluid communication with the pump;
wherein the liquid stored in the bladder is adapted to flow from the bladder to the container, and the pump is adapted to draw the liquid from the container and dispense the liquid through the dispensing conduit.

2. The liquid storage and dispensing system according to claim 1 wherein the bladder is adapted to be filled with the liquid by supplying the container with the liquid, which flows from the container to the bladder.

3. The liquid storage and dispensing system according to claim 1 wherein the pump is a manual pump.

4. The liquid storage and dispensing system according to claim 1 wherein the liquid is fuel.

5. The liquid storage and dispensing system according to claim 4 and further comprising an electrical ground mounted to the container.

6. The liquid storage and dispensing system according to claim 1 wherein the bladder is made of a polymer.

7. The liquid storage and dispensing system according to claim 6 wherein the bladder is made from at least one of a thermoplastic elastomer, a thermoplastic urethane, and a thermoset rubber.

8. The liquid storage and dispensing system according to claim 7 wherein the bladder is made from one of a nitrile rubber and a polyurethane.

9. The liquid storage and dispensing system according to claim 1 wherein the bladder is made of a composite fabric.

10. The liquid storage and dispensing system according to claim 9 wherein the bladder is made of a polymer reinforced aramid.

11. The liquid storage and dispensing system according to claim 1 wherein the bladder is connected to the container through a disconnectable coupling.

12. The liquid storage and dispensing system according to claim 11 wherein the bladder is connected to a hose that is connected to the container by the disconnectable coupling.

13. The liquid storage and dispensing system according to claim 12 wherein the disconnectable coupling is a quick connect coupling.

14. The liquid storage and dispensing system r according to claim 12 wherein the bladder is collapsible.

15. The liquid storage and dispensing system according to claim 14 wherein the bladder and container are sized so that the bladder, when collapsed, can fit in the container.

16. The liquid storage and dispensing system according to claim 15 wherein the hose, the disconnectable coupling, the pump, and the dispensing conduit are sized to fit in the container.

17. The liquid storage and dispensing system according to claim 1 wherein the liquid stored in the bladder is adapted to flow from the bladder to the container under the force of gravity.

18. A liquid storage and dispensing kit comprising:
a collapsible bladder for storing a liquid and having an expanded state when the collapsible bladder is filled with the liquid and a collapsed state when the collapsible bladder is substantially empty, the collapsible bladder having an outlet opening;
a pump adapted to be connected to the outlet opening of the collapsible bladder for drawing liquid from the collapsible bladder when the collapsible bladder contains the liquid;
a dispensing conduit adapted to be coupled to the pump for dispensing the liquid drawn from collapsible bladder; and
a container sized to store the pump, the dispensing conduit, and the collapsible bladder only when the collapsible bladder is in the collapsed state.

19. The liquid storage and dispensing kit according to claim 18 wherein the container is adapted to be connected between the pump and the collapsible bladder to facilitate filling the bladder with liquid and dispensing the liquid from the collapsible bladder.

20. The liquid storage and dispensing kit according to claim 18 wherein the liquid is fuel.

21. The liquid storage and dispensing kit according to claim 18 wherein the pump is a manual pump.

22. The liquid storage and dispensing kit according to claim 18 wherein the collapsible bladder is made of a polymer.

23. The liquid storage and dispensing kit according to claim 22 wherein the collapsible bladder is made from at least one of a thermoplastic elastomer, a thermoplastic urethane, and a thermoset rubber.

24. The liquid storage and dispensing system according to claim 23 wherein the bladder is made from one of a nitrile rubber and a polyurethane.

25. The liquid storage and dispensing kit according to claim 18 wherein the collapsible bladder is made of a composite fabric.

26. The liquid storage and dispensing kit according to claim 25 wherein the collapsible bladder is made of a polymer reinforced aramid.

27. The liquid storage and dispensing kit according to claim 18 and further comprising a disconnectable coupling adapted to connect the collapsible bladder to the container.

28. The liquid storage and dispensing kit according to claim 27 and further comprising a hose adapted to be connected to the disconnectable coupling to connect the collapsible bladder to the container.

29. The liquid storage container according to claim 28, wherein the disconnectable coupling is a quick connect coupling.

30. The liquid storage container according to claim 28 wherein the hose and the disconnectable coupling are sized to fit in the container with the pump, the dispensing conduit, and the bladder when the collapsible bladder is in the collapsed state.

31. A method of constructing a remote liquid storage facility comprising the steps of:
providing a liquid storage and dispensing kit according to claim 18 in a first location;
packing the collapsible bladder, the pump, and the dispensing conduit into the container at the first location;
transporting the packed container to a second location remote from the first location;
unpacking the container at the second location;
coupling the collapsible bladder to the container, coupling the pump to the container; and
coupling the dispensing conduit to the pump.

32. The method according to claim 31 and further comprising unfolding the collapsible bladder and laying it flat on a support surface.

33. The method according to claim 31 wherein the assembling step includes folding the collapsible bladder into a size to fit within the container.

34. The method according to claim 31 and further comprising filling the collapsible bladder with a liquid through the container.

35. The method according to claim 34 and further comprising dispensing the liquid from the collapsible bladder through the container.

36. The method according to claim 35 wherein the dispensing step includes pumping the liquid from the container through the dispensing conduit.
